(19) United States
(12) Patent Application Publication
(10) Pub. No.: US 2019/0170408 A1
(43) Pub. Date: Jun. 6, 2019

(54) MAGNETOCALORIC CYCLE DEVICE AND ELEMENT BED FOR THE SAME

(71) Applicant: DENSO CORPORATION, Kariya-city (JP)

(72) Inventor: Kazuki IWAYA, Kariya-city (JP)

(21) Appl. No.: 16/204,038

(22) Filed: Nov. 29, 2018

(30) Foreign Application Priority Data
Dec. 5, 2017 (JP) 2017-233625

(51) Int. Cl. F25B 21/00; H01F 1/01

(52) U.S. Cl. CPC F25B 21/00; F25B 2321/0022; H01F 1/015

(57) ABSTRACT

A magnetocaloric effect element performs a magnetocaloric effect. The magnetocaloric effect element is accommodated in a container. The container has a container member which provides walls of the container. The container member is made of a nonmagnetic material. The container has a reinforcing member which is provided partially in the container and reinforces the container member. The container member is made of a magnetic material. The reinforcing member has a cross section that is vertically long with respect to the magnetic flux supplied to the magnetocaloric effect element.

### CROSS REFERENCE TO RELATED APPLICATION

The present application is based on and claims the benefit of priority of Japanese Patent Application No. 2017-233625, filed on Dec. 5, 2017, the disclosure of which is incorporated herein by reference.

### TECHNICAL FIELD

The disclosure in this specification relates to a magnetocaloric cycle device and an element bed for the same.

### BACKGROUND ART

Patent Literature JP2008-51410A discloses a magnetocaloric cycle device and an element bed for the same. The so-called element bed includes a magnetocaloric effect element and a container. The container contains a magnetocaloric effect element. The container allows a magnetic field to be applied to the magnetocaloric effect element, and allows a heat transport medium to flow so as to perform a heat exchange with the magnetocaloric effect element.

### SUMMARY

In the prior art, material and/or shape of the container is limited in order to allow application of the magnetic field to the magnetocaloric effect element. Conversely, magnetically desirable containers may cause mechanical strength deficiencies. When the container receives the pressure of the heat transport medium, the pressure resistance of the container may be impaired. Also, additionally or alternatively, it is desirable that containers have fewer losses such as magnetic losses, thermal losses, losses associated with eddy currents, and the like. Further improvement is required on the magnetocaloric cycle device and its element bed in view of the above described difficulties and/or not mentioned other difficulties.

It is a disclosed one object to provide a magnetocaloric cycle device and an element bed which are provided with containers advantageous from a magnetic point of view and from a mechanical strength point of view.

It is another disclosed object to provide a magnetocaloric cycle device and an element bed capable of suppressing loss caused by a container.

An element bed for a magnetocaloric cycle device disclosed herein comprises: a magnetocaloric effect element performing a magnetocaloric effect; and a container containing the magnetocaloric effect element, the container has a container member for providing walls of the container, and a reinforcing member disposed partially on the container member for reinforcing the container member.

According to the disclosed element bed for a magnetocaloric cycle device, the container of the element bed can be reinforced. By reinforcing the container from the viewpoint of mechanical strength, it is possible to improve the container from a magnetic viewpoint. As a result, it is possible to provide the container advantageous from the viewpoint of magnetic and mechanical strength.

A magnetocaloric cycle device disclosed herein comprises: the element bed described above; a magnetic field modulation device for modulating a magnetic field applied to the magnetocaloric effect device; and a heat transport device for generating a reciprocating flow of a heat transport medium that performs a heat exchange with the magnetocaloric effect device.

According to the disclosed magnetocaloric cycle device, a magnetocaloric cycle device having a container advantageous from a magnetic viewpoint and mechanical strength viewpoint is provided.

A magnetocaloric cycle device disclosed herein comprises: an element bed in which a reinforcing member is arranged at least on an overlapping wall; a magnetic field modulation device for modulating a magnetic field applied to the magnetocaloric effect device; and a heat transport device for generating a reciprocating flow of a heat transport medium that performs a heat exchange with the magnetocaloric effect device, further comprising: a bed group in which the plurality of element beds are arranged along a circumferential direction, wherein the direction of the magnetic flux is a radial direction, the overlapping wall is an outer wall and an inner wall facing in a radial direction, and a plurality of element beds are arranged so as to face side walls other than the overlapping wall.

According to the disclosed magnetocaloric cycle device, the reinforcing member is disposed on the overlapping wall that transmits the main magnetic flux acting on the magnetocaloric effect element. In a configuration in which a plurality of element beds are arranged along the circumferential direction, the outer wall and the inner wall face in the radial direction. Moreover, since the direction of the magnetic flux is a radial direction, the overlapping walls are the outer wall and the inner wall. Therefore, the reinforcing member can reinforce the outer wall and the inner wall which are required to have relatively high strength.

The disclosed aspects in this specification adopt different technical solutions from each other in order to achieve their respective objectives. Reference numerals in parentheses described in claims and this section exemplarily show corresponding relationships with parts of embodiments to be described later and are not intended to limit technical scopes. The objects, features, and advantages disclosed in this specification will become apparent by referring to following detailed descriptions and accompanying drawings.

### BRIEF DESCRIPTION OF DRAWINGS

FIG. 1 is a block diagram showing a device of a first embodiment;

FIG. 2 is a cross sectional view showing the device of the first embodiment;

FIG. 3 is a perspective view showing an element bed of the first embodiment;

FIG. 4 is a cross sectional view taken along a line IV-IV in FIG. 3;

FIG. 5 is a cross sectional view taken along a line V-V in FIG. 3;

FIG. 6 is a cross sectional view taken along a line VI-VI in FIG. 3;

FIG. 7 is a perspective view showing an element bed of a second embodiment;

FIG. 8 is a perspective view showing an element bed of a the third embodiment;

FIG. 9 is a perspective view showing an element bed of a fourth embodiment;

FIG. 10 is a perspective view showing an element bed of a fifth embodiment;

FIG. 11 is a perspective view showing an element bed of a sixth embodiment;

FIG. 12 is a perspective view showing an element bed of a seventh embodiment;

FIG. 13 is a graph showing a temperature distribution of the element bed;

FIG. 14 is a cross sectional view showing a manufacturing method of an eighth embodiment;

FIG. 15 is a perspective view showing a manufacturing method of a ninth embodiment;

FIG. 16 is a perspective view showing an element bed of a tenth embodiment;

FIG. 17 is a cross sectional view taken along a line XVII-XVII in FIG. 16;

FIG. 18 is a cross sectional view taken along a line XVIII-XVIII in FIG. 16;

FIG. 19 is a cross sectional view taken along a line XIX-XIX in FIG. 16;

FIG. 20 is a graph showing a temperature distribution of the element bed;

FIG. 21 is a perspective view showing a manufacturing method of an eleventh embodiment;

FIG. 22 is a cross sectional view showing a reinforcing member of a twelfth embodiment;

FIG. 23 is a cross sectional view showing a reinforcing member of a thirteenth embodiment;

FIG. 24 is a cross sectional view showing a reinforcing member of a fourteenth embodiment; and

FIG. 25 is a cross sectional view showing a reinforcing member of a fifteenth embodiment.

### DESCRIPTION OF EMBODIMENTS

Hereinafter, a plurality of embodiments will be described with reference to the drawings. In some embodiments, parts that are functionally and/or structurally corresponding and/or associated are given the same reference numerals, or reference numerals with different hundred digit or more digits. For corresponding parts and/or associated parts, reference can be made to the description of other embodiments.

### First Embodiment

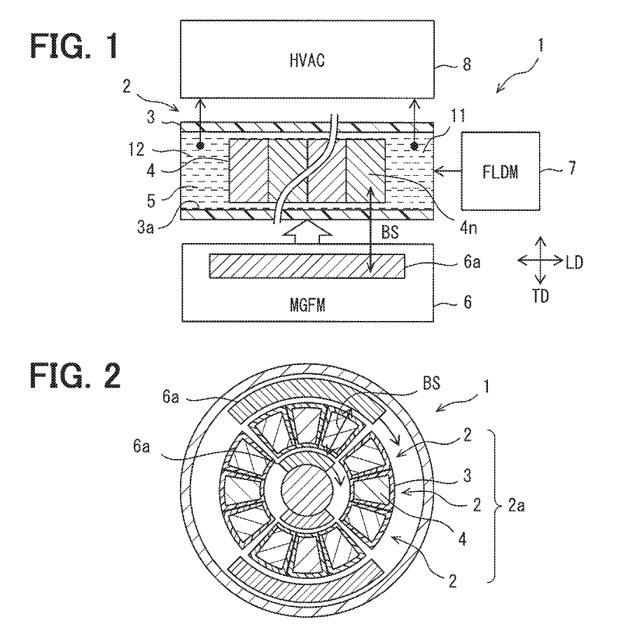

FIG. 1 is a block diagram showing a magnetocaloric cycle device. The magnetocaloric cycle device provides a magnetocaloric effect type heat pump device 1. The magnetocaloric effect type heat pump device 1 is called an MHP device 1. MHP is an abbreviation of Magnetocaloric effect Heat Pump. The MHP device 1 is also called a magnetic heat pump device. The MHP device 1 provides a vehicle air conditioner.

In this specification the term “vehicle” is used in a broad sense. That is, the term “vehicle” includes a moving body having an occupant's compartment or a luggage compartment, for example, a motor vehicle, a ship, an airplane. In addition, the term “vehicle” includes a simulation equipment, an amusement equipment and the like.

In this specification the term “heat pump device” is used in a broad sense. That is, the term “heat pump device” includes both a device utilizing cold heat obtained by a heat pump device and a device utilizing heat obtained by a heat pump device. Devices that utilize a cold energy may also be referred to as refrigeration cycle devices. Hence, in this specification the term “heat pump device” is used as a concept encompassing a refrigeration cycle device.

The MHP device 1 includes a magnetocaloric effect element bed 2. The magnetocaloric effect element bed 2 is called an element bed 2. The element bed 2 has a container 3 and a magnetocaloric element 4. The magnetocaloric element 4 is called an MCE element 4. The MHP device 1 utilizes the magnetocaloric effect of the MCE element 4. The container 3 partitions and forms a work chamber 3a. The container 3 accommodates the MCE element 4. The MCE element 4 is accommodated in the work chamber 3a. The MCE element 4 is disposed between a high temperature end 11 which is an end region at one end of the work chamber 3a and a low temperature end 12 which is an end region at the other end of the working chamber 3a. The container 3 allows a magnetic field to be applied to the magnetocaloric effect element 4, and allows a heat transport medium 5 to flow so as to perform a heat exchange with the magnetocaloric effect element 4. The heat transport medium 5 can be provided by a fluid such as antifreeze, water, oil, gas or the like. Most of the container 3 is made of nonmagnetic material.

The MCE element 4 includes a magnetic work material having a magnetocaloric effect. MCE is an abbreviation of a Magneto-Caloric Effect. The NICE element 4 is disposed between the high temperature end 11 and the low temperature end 12. The MCE element 4 generates a heat discharge and a heat absorption due to a change of strength of the external magnetic field. The container 3 and the MCE element 4 are arranged so as to form a flow path of the heat transport medium 5.

The MCE element 4 has a plurality of element groups 4n. The illustrated number of element groups 4n is just an example. The MCE element 4 may have n groups of element groups 4n. The plurality of element groups 4n share a temperature gradient (temperature distribution) as a target value obtained during a steady operation. The temperature gradient produces the high-temperature end 11 and the low-temperature end 12. The terms “high-temperature end 11” and “low-temperature end 12” refer to partial regions in the element bed 2. The high-temperature end 11 and the low-temperature end 12 indicate a region outside the MCE element 2 in the longitudinal direction LD. In many cases, pipes, pumps, valve mechanisms and the like are arranged outside the high-temperature end 11 and the low-temperature end 12. The temperature gradient is obtained as a result of the MHP apparatus 1 being operated for a long time. For example, the temperature gradient obtained during the steady operation provides high and low temperatures that can be used as the vehicle air conditioner. The plurality of element groups 4n are arranged along the longitudinal direction LD of the MCE element 4, that is, along the flow direction of the heat transport medium 5. The arrangement of the plurality of element groups 4n in such the MCE element 4 is called Cascade arrangement.

Materials constituting each of the plurality of element groups 4n have different Curie temperatures. The plurality of element groups 4n demonstrate a high magnetocaloric effect (ΔS(J/kgK)) in different temperature zones. The element group 4n close to the high-temperature end 11 has a material composition demonstrating a high magnetocaloric effect in a vicinity of the temperature appearing at the high-temperature end 11 in the steady operation state. The element group 4n close to a middle temperature portion has a material composition demonstrating a high magnetocaloric effect in a vicinity of the temperature appearing at the middle temperature portion in the steady operation state. The element group 4n close to the low-temperature end 12 has a material composition demonstrating a high magnetocaloric effect in a vicinity of the temperature appearing at the low-temperature end 12 in the steady operation state.

The MCE element 4 generates the heat discharge by applying the external magnetic field and generates the heat absorption by removal of the external magnetic field. The MCE element 4, when the electron spin is aligned in the magnetic field direction by applying the external magnetic field, decreases magnetic entropy and demonstrates increasing of a temperature by discharging heat. Also, the MCE element 4, when the electron spin becomes cluttered by removing the external magnetic field, increases the magnetic entropy and demonstrates decreasing of a temperature by absorbing heat. The NICE element 4 is made of a magnetic material that performs a high magnetocaloric effect in a normal temperature range. The magnetic material may be, for example, a gadolinium-based material. It may also be a mixture of manganese, iron, phosphorus and germanium.

The MHP device 1 includes a magnetic field modulation device 6 (MGFM) and a heat transport device 7 (FLDM). The magnetic field modulation device 6 and the heat transport device 7 make the MCE element 4 function as an AMR (Active Magnetic Refrigeration) cycle. The magnetic field modulation device 6 and the heat transport device 7 operate synchronously.

The magnetic field modulation device 6 applies the external magnetic field to the MCE element 4 and modulates the external magnetic field so as to increase or decrease an intensity of the external magnetic field. The external magnetic field is given along the thickness direction TD. A magnetic flux BS penetrating the container 3 along the thickness direction TD is illustrated. The magnetic field modulation device 6 periodically switches between an excitation state in which the MCE element 4 is placed in a strong magnetic field and a demagnetization state in which the MCE element 4 is placed in a weak magnetic field or in a zero magnetic field. The magnetic field modulation device 6 modulates the external magnetic field so as to periodically repeat the magnetization period in which the MCE element 4 is placed in a strong external magnetic field and the demagnetization period in which the MCE element 4 is placed in an external magnetic field weaker than the magnetization period. The magnetic field modulation device 6 can comprise a magnetic power source for generating the external magnetic field, for example a permanent magnet or an electromagnet.

The magnetic field modulation device 6 includes a magnetic member 6a including a permanent magnet. The magnetic member 6a is capable of applying the external magnetic field to the entire MCE element 4. The total length of the magnetic member 6a is longer than the total length of the MCE element 4. The magnetic member 6a is arranged so as to overlap with the MCE element 4. The magnetic member 6a is arranged so as to overlap with the element bed 2. The magnetic member 6a is disposed so as to overlap with the center area of the element bed 2 where the MCE element 4 is disposed. Further, the magnetic member 6a is arranged so as to overlap with the high-temperature end 11. The magnetic member 6a also gives a change in the external magnetic field to the high-temperature end 11. The magnetic member 6a is arranged so as to overlap the low-temperature end 12. The magnetic member 6a also changes the external magnetic field to the low-temperature end 12. In this manner, the magnetic field modulation device 6 also causes a change in the external magnetic field to be applied to the end region provided by the element bed.

The magnetic field modulation device 6 is provided by a mechanism which moves the element bed 2 and/or the permanent magnet and periodically and relatively changes a distance between the element bed 2 and the permanent magnet. The magnetic field modulation device 6 may include, for example, a rotation mechanism for rotating the permanent magnet with respect to the fixed element bed 2.

The heat transport device 7 includes a fluid device for flowing the heat transport medium 5 for transporting the heat that the MCE element 4 discharges or absorbs. The heat transport device 7 is a device for flowing the heat transport medium 5 for heat exchange with the MCE element 4 along the MCE element 4. The heat transport device 7 causes the heat transport medium 5 to flow so as to generate the high-temperature end and the low-temperature end in the MCE element 4. The heat transport device 7 reciprocally flows the heat transport medium 5 synchronously with a change in the external magnetic field by the magnetic field modulation device 6, for example. The heat transport device 7 may include a pump for flowing the heat transport medium 5. The heat transport device 7 may comprise a plurality of passages for controlling the flow of the heat transport medium 5 and a valve mechanism.

The MHP device 1 has an air conditioner 8 (HVAC) for providing a vehicle air conditioner. The air conditioner 8 is also referred to as a unit for heating, ventilation, and air conditioning. The air conditioner 8 utilizes the high temperature obtained at the high-temperature end 11 and/or the low temperature obtained at the low-temperature end 12. The high temperature and/or the low temperature may be took away from the MCE element 4 or take away from the heat transport medium 5.

In FIG. 2, the MHP device 1 has the plurality of element beds 2. The plurality of element beds 2 provide a plurality of element bed groups 2a. The plurality of element beds 2 belong to one element bed group 2a. The plurality of element beds 2 are arranged between the magnetic members 6a and 6a which are rotated by a power source. In the illustrated example, the MHP apparatus 1 has four element bed groups 2a. One element bed group 2a has three element beds 2. The plurality of element beds 2 belonging to one element bed group 2a are simultaneously supplied with the heat transport medium 5 in the same flow direction. The plurality of element beds 2 belonging to one element bed group 2a are placed in the magnetization period or demagnetization period almost at the same time. The shape of the container 3 is shown slightly exaggerated. The container 3 is a cylindrical shape. The container 3 has a cross-sectional shape which can be referred to as a square tube or a cylinder. The cross-sectional shape of the container 3 may also be called a fan shape.

The container 3 has walls overlapping with the MCE element 4 with respect to the direction of the magnetic flux BS supplied to the MCE element 4, i.e., walls overlapping the MCE element 4 in the thickness direction TD. This wall is called an overlapping wall. The overlapping wall extends orthogonally to the direction of the magnetic flux BS. The overlapping wall spreads to face in the radial direction. The overlapping walls face radially inward and radially outward of the container 3. The container 3 has side walls other than the overlapping walls. The side walls face both circumferential sides of the container 3.

Since many magnetic fluxes BS making an interlinkage with the MCE element 4 pass through the overlapping walls, the overlapping walls are largely related to the magnetic loss. The thinner the overlapping wall, the higher the strength of the effective magnetic flux BS. A part of the magnetic flux BS may pass through the side wall and make the interlinkage with the MCE element 4. However, the magnetic flux BS which makes the interlinkage with the MCE element 4 and passes through the side wall is still small. For this reason, the side wall has a relatively small involvement in magnetic loss. From such a viewpoint, the overlapping wall is required to have a structure satisfying the strength required for the container 3 by a thin thickness.

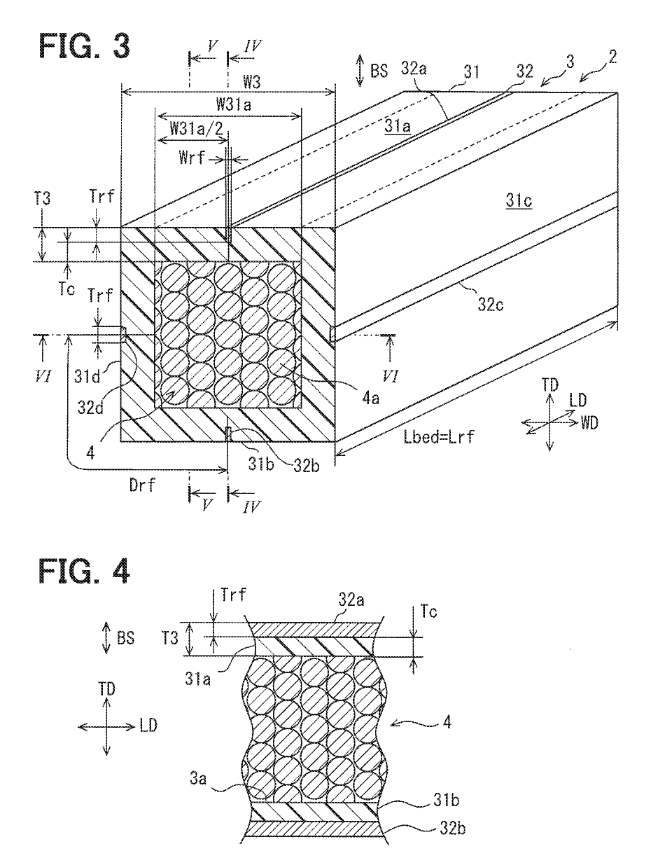

In FIG. 3, the element bed 2 is somewhat schematically drawn. The thickness direction TD corresponds to the radial direction, and the width direction WD corresponds to the circumferential direction. The longitudinal direction LD is also the flow direction of the heat transport medium 5. The element bed 2 has the container 3 and the MCE element 4. The container 3 has a cylindrical shape extending along the longitudinal direction LD. The container 3 has a container member 31 and at least one reinforcing member 32. The container 3 has a plurality of reinforcing members 32a, 32b, 32c and 32d.

The MCE element 4 is provided by a plurality of particles 4a. The particle 4a may be called a grain. The plurality of particles 4a are filled in the container 3. The plurality of particles 4a provides a flow path for the heat transport medium 5 therebetween. The cross-sectional area A4 provided by the MCE element 4 is a part of the cross-sectional area A3 provided by the container 3. The MCE element 4 is arranged substantially uniformly in its installation region. As a result, the MCE element 4 and the flow path are distributed almost evenly. The flow path cross-sectional area A4 is the sum of a plurality of dispersed flow paths in a cross section perpendicular to the longitudinal direction LD. The distributed arrangement of the flow paths provides good heat exchange between the MCE element 4 and the heat transport medium 5. The MCE element 4 can be provided in various shapes such as a plate shape and a block shape forming a plurality of micro channels for flowing the heat transport medium 5.

The container member 31 is made of a nonmagnetic material. The container member 31 has airtightness for holding the heat transport medium 5 without leaking. The container member 31 provides pressure resistance to withstand a pressure of the heat transport medium 5. The container member 31 is made of a nonmagnetic material.

The reinforcing member 32 is partially provided in the container member 31. The reinforcing member 32 reinforces the strength of the wall provided by the container member 31. Therefore, in this embodiment, the pressure resistance of the container 3 is provided by the container member 31 and the reinforcing member 32.

The reinforcing member 32 has a mechanical strength per unit volume which is larger than that of the container member 31. In particular, the longitudinal elastic modulus of the reinforcing member 32 in the thickness direction TD is higher than the longitudinal elastic modulus of the container member 31. As a result, the longitudinal elastic modulus of the container 3 is also high. The reinforcing member 32 may be provided by a metal. The reinforcing member 32 may be provided by a nonmagnetic metal such as aluminum, nonmagnetic stainless steel, titan or carbon. The reinforcing member 32 may be desirably provided by a material that has a low electric resistivity. In this case, it is expected to reduce a heat generation due to an eddy current loss. The reinforcing member 32 may be provided by a conductive material. The reinforcing member 32 may be provided by a magnetic material. The reinforcing member 32 may be provided by a magnetic metal such as iron, magnetic steel sheet, or magnetic stainless steel. In this embodiment, the reinforcing member 32 is made of iron.

The material of the container member 31 has a predetermined thermal conductivity. The thermal conductivity of the material of the container member 31 is lower than a thermal conductivity of a material of the reinforcing member 32. Since the container member 31 provides most of the container 3, it contributes to a low thermal conductivity of the container 3 itself. The container member 31 contributes to suppressing heat transfer between the high-temperature end 11 and the low-temperature end 12. A resistivity of the container member 31 is higher than a resistivity of the reinforcing member 32. Again, since the container member 31 provides most of the container 3, it contributes to increasing the resistivity of the container 3 itself. As a result, the container 3 provides a high longitudinal modulus, a low thermal conductivity and a high electrical resistivity. With the characteristics of the material forming the container 3, it is possible to achieve pressure resistance required for the container 3, suppress loss due to heat conduction, and reduce loss due to eddy current.

The material of the container member 31 has a predetermined thermal conductivity. The thermal conductivity of the material of the container member 31 is lower than the thermal conductivity of the material of the reinforcing member 32. The reinforcing member 32 promotes heat transfer between the high-temperature end 11 and the low-temperature end 12. However, in the cross section perpendicular to the longitudinal direction LD, a cross-sectional area provided by the reinforcing member 32 is smaller than a cross-sectional area provided by the container member 31. Therefore, the heat transfer through the reinforcing member 32 is restricted within an allowable range.

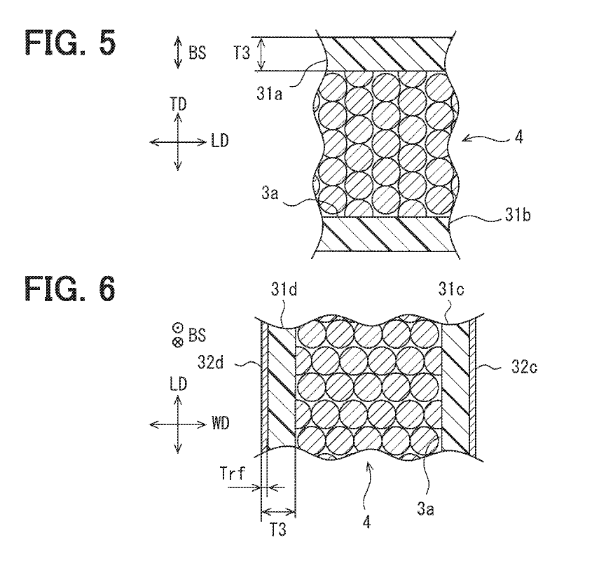

FIG. 4 shows a cross section taken along a line IV-IV in FIG. 3. FIG. 5 shows a cross section taken along a line V-V in FIG. 3. FIG. 6 shows a cross section taken along a line VI-VI of FIG. 3. In FIGS. 3 to 6, a shape of the container 3 is illustrated in detail.

The container 3 has a width W3. The width W3 is also the width of the container member 31. The container member 31 is cylindrical. The container member 31 defines the outer shape of the container 3. Here, the cross section of the container 3 is described as a square. The container 3 has an outer wall 31a and an inner wall 31b as overlapping walls. The container 3 has side walls 31c and 31d. The boundary between the overlapping walls and the side walls is illustrated by a dashed line. The width W31a of the outer wall 31a and the inner wall 31b as the overlapping walls are smaller than the width W3. Since the container 3 has a multi-sided or polygonal cylindrical shape, the corner portion belongs to the side wall.

The reinforcing member 32 extends along the longitudinal direction LD. A length Lrf of the reinforcing member 32 is equal to a length Lbed of the container 3. The reinforcing member 32 is partially disposed on the container 3. The reinforcing member 32 is partially disposed in the container member 31. The reinforcing member 32 contributes to suppress a thickness of the container member 31.

Each of the plurality of walls 31a, 31b, 31c and 31d provided by the container member 31 has a plurality of reinforcing members 32a, 32b, 32c and 32d, respectively. The outer wall 31a is reinforced by the reinforcing member 32a. The inner wall 31b is reinforced by the reinforcing member 32b. The side wall 31c is reinforced by the reinforcing member 32c. The side wall 31d is reinforced by the reinforcing member 32d. The reinforcing member 32 is arranged so as to extend along the center portion of the corresponding wall. For example, the reinforcing member 31a is disposed at the center of the width W31a of the outer wall 31a. The reinforcing member 32a reduces the width of the wall provided only by the container member 31. Specifically, the wall provided only by the container member 31 has a width W31a/2.

The reinforcing member 32 suppresses a width of a beam of the wall provided by the container member 31. For example, the outer wall 31a receives an inner pressure in the working chamber 3a at the width W31a. If the reinforcing member 32a is absence, the outer wall 31a may be curved over the length of the width W31a. However, by disposing the reinforcing member 32a, the outer wall 31a is deformed over the width W31a/2. As a result, a deformation amount of the wall, i.e., a deformation amount of the container 3 is suppressed.

The reinforcing member 32 is arranged at regular intervals in a cross section perpendicular to the longitudinal direction LD of the container 3. There is a wall of the container member 31 with a surface length Drf between the two adjacent reinforcing members 32 in a cross section perpendicular to the longitudinal direction LD. The arrangement of the plurality of reinforcing members 32a, 32b, 32c and 32d may not be exactly equally spaced. The plurality of reinforcing members 32a, 32b, 32c and 32d may be distributed so as to reinforce the container member 31. It is preferable that the reinforcing member 32 is provided at least on the outer wall 31a and/or the inner wall 31b. Thereby, the outer wall 31a and/or the inner wall 31b are reinforced. The reinforcing member 32 may be provided on the side wall 31c and/or the side wall 31d. As a result, the pressure resistance of the entire container 3 is enhanced.

The reinforcing member 32 has a width Wrf of a single side and a height Trf of a long side in a cross section perpendicular to the longitudinal direction LD. The width Wrf is smaller than the height Trf (Wrf<Trf). The height Trf is a direction along the magnetic flux BS. The width Wrf intersects the magnetic flux BS. In other words, the cross section of the reinforcing member 32 has a long side and a short side. The reinforcing member 32 is arranged so that the long side is parallel to the magnetic flux BS. The reinforcing member 32 can be said to have a vertically elongated cross section along the direction of the magnetic flux BS supplied to the MCE element 4. The vertically elongated cross section suppresses an interlinkage between the magnetic flux BS and the reinforcing member 32 and suppresses a loss caused by the interlinkage. The reinforcing member 32 having a vertically elongated cross section suppresses, for example, a loss due to an eddy current. The elongated cross section effectively increases the strength of the container member 31 in the thickness direction TD. For example, the elongated cross section provides strength against the internal pressure of the working chamber 3a.

The reinforcing member 32 is disposed on an outside of the wall of the container 3. The reinforcing member 32a occupies an outer side in the radial direction of the outer wall 31a. The height Trf of the reinforcing member 32 occupies a part of the thickness T3 of the outer wall 31a. The container member 31 has a thickness Tc as a cylindrical portion for partitioning the working chamber 3a. The cylindrical portion is formed by a continuous material to provide sealing properties. The cylindrical portion is continuous over an entire circumference and over an entire length. The thickness Tc of the cylindrical portion is larger than the height Trf of the reinforcing member 32a.

In this embodiment, all of the outer wall 31a, the inner wall 31b, the side wall 31c, and the side wall 31d have the thickness T3. The thickness T3 of these walls is a relatively thin thickness satisfying the pressure resistance required of the container 3 under reinforcement by the reinforcing member 32. The side wall (the side wall 31c and the side wall 31d) may be formed thicker than the overlapping wall (the outer wall 31a and the inner wall 31b).

According to the embodiment described above, the container 3 has the container member 31 and the reinforcing member 32. Thus, it is possible to select the material and shape of the container member 31 from a magnetic viewpoint. In addition, the reinforcing member 32 can satisfy the requirements from a mechanical strength viewpoint. Therefore, it is possible to provide the element bed 2 and the MHP device 1 having the container 3 which is advantageous from the magnetic viewpoint and the mechanical strength viewpoint.

In this embodiment, the reinforcing member 32 is arranged on the outer wall 31a and/or the inner wall 31b which are overlapping walls overlapping the MCE element 4 with respect to the magnetic flux BS. For this reason, it is possible to provide the container 3 with walls advantageous in the magnetic viewpoint and the mechanical strength viewpoint.

In this embodiment, the container member 31 made of the nonmagnetic material and the reinforcing member 32 made of the magnetic material are used. This provides high flexibility in material selection.

In this embodiment, the reinforcing member 32 has an elongated cross section. The elongated cross section suppresses an interlinkage with the magnetic flux BS. Therefore, a magnetic loss in the container 3 is suppressed. In this embodiment, a metal reinforcing member 32 is used. If the magnetic flux BS making the interlinkage with the metallic reinforcing member 32 changes, an eddy current loss occurs in the reinforcing member 32. The elongated cross section suppresses eddy current loss, for example.

Returning to FIG. 2, the MHP device 1 has the bed group 2a in which a plurality of element beds 2 are arranged along the circumferential direction. The direction of the magnetic flux BS supplied to the MCE element 4, in other words, the direction of the magnetic flux BS supplied by the magnetic field modulation device 6 is in the radial direction. The plurality of element beds 2 are arranged to face the side walls 31c and 31d other than the overlapping walls. The overlapping walls are the outer wall 31a and the inner wall 31b that face in the radial direction. In a configuration in which a plurality of element beds 2 are arranged along the circumferential direction as one element bed group 2a, the outer wall 31a and the inner wall 31b face in the radial direction. The reinforcing member 32 is disposed in an overlapping wall that transmits at least the main magnetic flux. In addition, since the direction of the magnetic flux BS is in the radial direction, the overlapping walls are the outer wall 31a and the inner wall 31b. Therefore, the reinforcing member 32 can reinforce the outer wall 31a and the inner wall 31b which are required to have relatively high strength.

### Second Embodiment

This embodiment is a modification in which the preceding embodiment is a base fundamental form. In the above embodiment, one reinforcing member is disposed on one wall. Alternatively, in this embodiment, a plurality of reinforcing members are arranged on one wall.

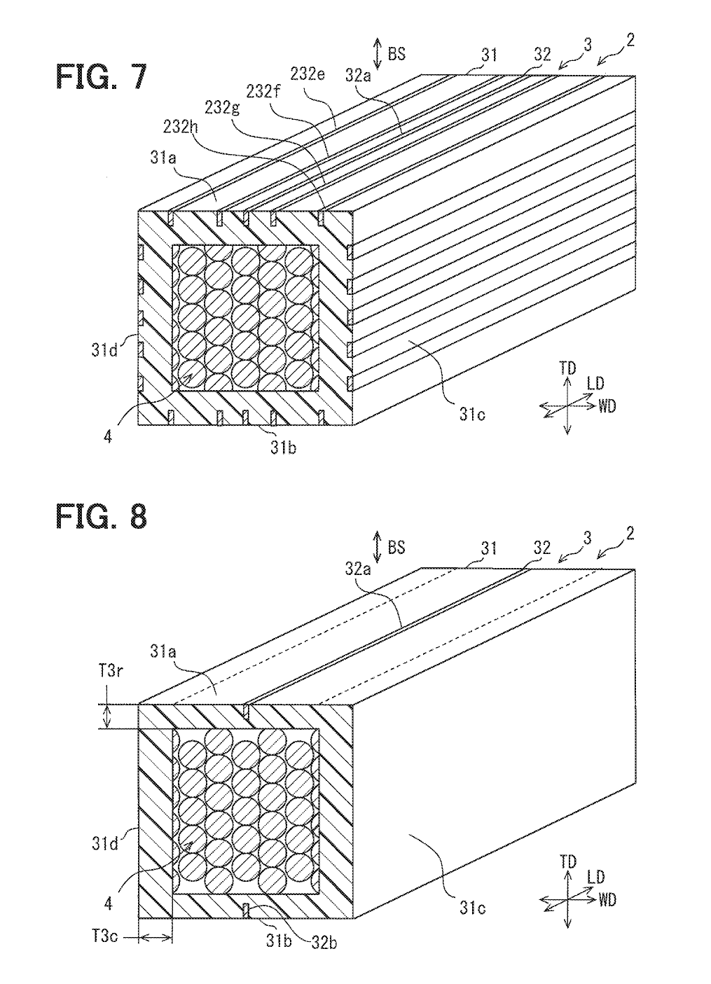

FIG. 7 shows an element bed 2 of this embodiment. Each of the plurality of walls 31a, 31b, 31c and 31d has a plurality of reinforcing members 32. The representative outer wall 31a has additional reinforcing members 232e, 232f, 232g and 232h in addition to the central reinforcing member 32a. The plurality of reinforcing members 32a, 232e, 232f, 232g and 232h provide density of the reinforcing members. The density is relatively high at a central region of a wall and is relatively low at both end regions of a wall. Therefore, the plurality of reinforcing members creates a density distribution along the width direction. The plurality of reinforcing members 32a, 232e, 232f, 232g and 232h arranged on one wall 31a makes it possible to improve the strength of the wall 31a.

### Third Embodiment

This embodiment is a modification in which the preceding embodiment is a base fundamental form. In the above embodiment, the reinforcing members are arranged on all the walls. Alternatively, the reinforcing member may be disposed only on the overlapping wall.

FIG. 8 shows an element bed 2 of this embodiment. The outer wall 31a as an overlapping wall has a reinforcing member 32a. The inner wall 31b as an overlapping wall has a reinforcing member 32b. The side wall 31c does not have the reinforcing member 32. The side wall 31d does not have the reinforcing member 32. In this way, the reinforcing member 32 may be disposed only on the overlapping wall.

The outer wall 31a and the inner wall 31b have a thickness T3r. The side wall 31c and the side wall 31d have a thickness T3c. The thickness T3r is smaller than the thickness T3c (T3c<T3r). The outer wall 31a and the inner wall 31b provide required strength by the reinforcing members 32a, 32b.

According to this embodiment, a material easy to pass through the magnetic flux BS can be utilized for the overlapping wall. Moreover, since the overlapping wall is thinner than the side wall, it is easy to pass the magnetic flux BS. Furthermore, by arranging the reinforcing member 32 at least on the overlapping wall, the overlapping wall is reinforced. For this reason, it is possible to utilize a material with low mechanical strength for overlapping walls or to make the overlapping wall thin. As a result, design requirements can be satisfied both in terms of magnetic and mechanical strength.

### Fourth Embodiment

This embodiment is a modification in which the preceding embodiment is a base fundamental form. In the above embodiment, the reinforcing member is disposed so as to be exposed on the outer surface of the wall. Alternatively, the reinforcing member may be disposed in an embedded condition in the wall.

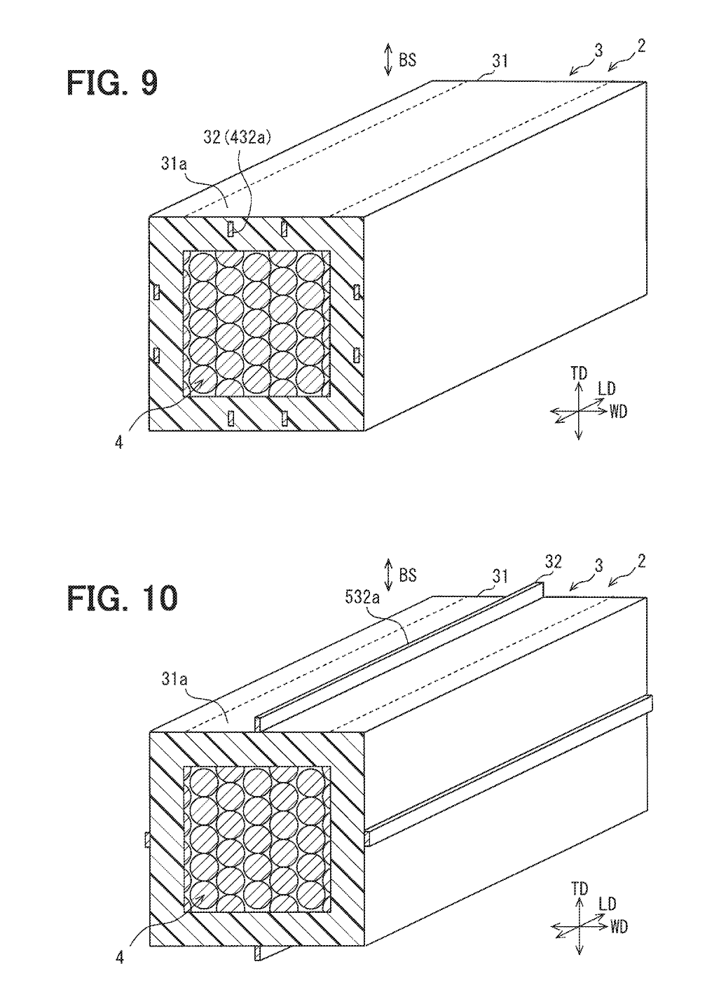

FIG. 9 shows an element bed 2 of this embodiment. The wall of the container member 31 has the reinforcing member 32 inside. The reinforcing member 32 is embedded in the wall of the container member 31. The reinforcing member 32 is buried. In the illustrated example, the reinforcing member 32 is exposed at the end surface of the container 3, but the reinforcing member 32 may be covered by the container member 31 also at the end surface. For example, at least one reinforcing member 432a is buried in the outer wall 31a. The outer wall 31a has a plurality of reinforcing members 432a. The reinforcing members may also be arranged in the other walls as well.

### Fifth Embodiment

This embodiment is a modification in which the preceding embodiment is a base fundamental form. In the above embodiment, the reinforcing member is disposed in the wall. Alternatively, the reinforcing member may be disposed so as to protrude from the outer surface of the wall.

FIG. 10 shows an element bed 2 of this embodiment. The wall of the container member 31 has the reinforcing member 32 on its outer surface. The reinforcing member 32 is adhered to the outer surface of the container member 31. For example, at least one reinforcing member 532a is attached to the outer wall 31a. The reinforcing member 532a suppresses the deformation amount of the outer wall 31a by reinforcing the container member 31. The reinforcing members may also be arranged in the other walls as well. In this embodiment as well, the overlapping wall is reinforced.

### Sixth Embodiment

This embodiment is a modification in which the preceding embodiment is a base fundamental form. In the above embodiment, the container 3 has a polygonal cylindrical shape. Alternatively, the container 3 may be a circular or an elliptical with no corners or planes.

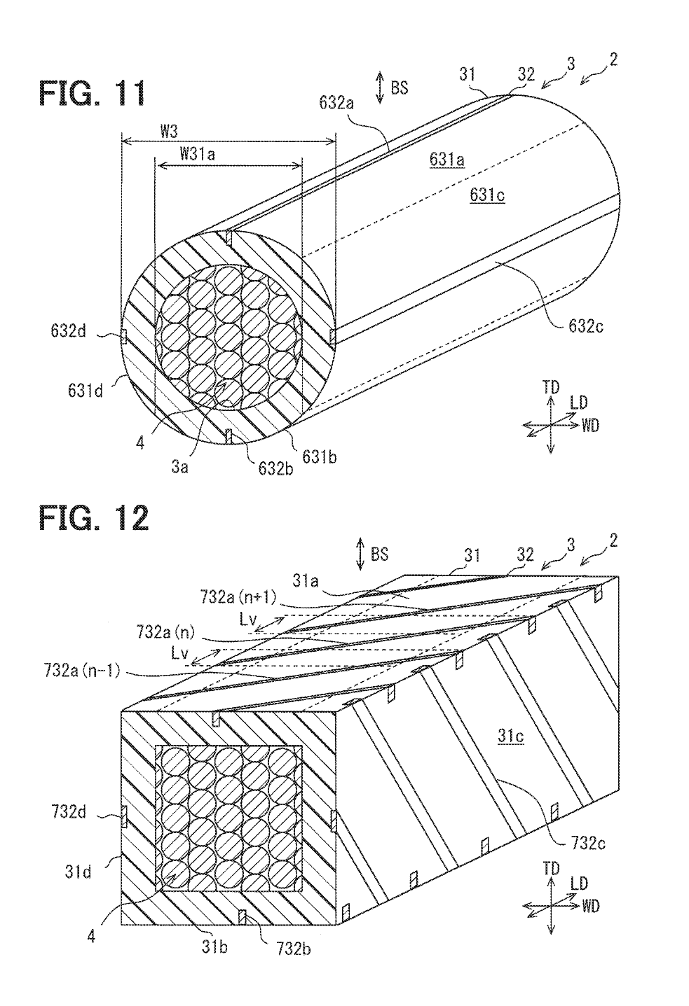

FIG. 11 shows an element bed 2 of this embodiment. The container 3 is cylindrical. In the container 3, a working chamber 3a is partitioned by an internal cavity of a circular cylinder. In the working chamber 3a, the MCE element 4 is accommodated. Even in the circular cylindrical container 3, it is possible to determine overlapping walls overlapping the MCE element 4 with respect to the direction of the magnetic flux BS and side walls. The outer wall 631a positioned radially outside with respect to the MCE element 4 is a curved surface. The inner wall 631b positioned radially inside with respect to the MCE element 4 is a curved surface. The outer wall 631a and the inner wall 631b provide overlapping walls. Portions connecting the outer wall 631a and the inner wall 631b are referred to as a side wall 631c and a side wall 631d.

Also in this embodiment, the reinforcing member 32 reinforces the wall provided by the container member 31. The container 3 has a width W3 with respect to the direction of the magnetic flux BS. The overlapping wall has a width W31a. The reinforcing member 632a reinforces the outer wall 631a as an overlapping wall. The reinforcing member 632b reinforces the inner wall 631b as an overlapping wall. The reinforcing member 632c reinforces the side wall 631c. The reinforcing member 632d reinforces the side wall 631d.

The shape of the container in this embodiment can be combined with other embodiments. For example, the thickness of the overlapping walls may be made thinner than the thickness of the side walls. In addition, the reinforcing member 32 may be provided only on the overlapping wall. Further, the overlapping wall may include a plurality of reinforcing members.

### Seventh Embodiment

This embodiment is a modification in which the preceding embodiment is a base fundamental form. In the above embodiment, the reinforcing member 32 extends only along the longitudinal direction LD. Alternatively, the reinforcing member may extend in a circumferential direction of the container 3. In addition, the reinforcing member 32 may extend with respect to both the longitudinal direction LD and the circumferential direction (both the thickness direction TD and the width direction WD), that is, may extend obliquely with respect to the longitudinal direction LD. Further, the reinforcing member 32 may have a plurality of reinforcing members spaced apart from each other in the longitudinal direction LD.

FIG. 12 shows an element bed 2 of this embodiment. The container 3 has a reinforcing member 32 extending obliquely with respect to the longitudinal direction LD on the wall provided by the container member 31. The thermal conductivity of the material of the container member 31 is lower than the thermal conductivity of the material of the reinforcing member 32. The container 3 has a plurality of reinforcing members 32 which elongated spirally along the longitudinal direction LD. The plurality of reinforcing members 32 arranged on one wall are not continuous along the longitudinal direction LD. However, the plurality of reinforcing members 32 are spaced apart from each other by a predetermined distance in the circumferential direction, and are arranged in parallel by a predetermined length. In other words, the plurality of reinforcing members 32 arranged on one wall are overlapped. A space between the two reinforcing members 32 is filled with the container member 31. Such the plurality of non-continuous reinforcing members 32 suppress heat transfer along the longitudinal direction LD between the high-temperature end 11 and the low-temperature end 12 while increasing the strength of the container 3.

Heat transfer through a plurality of reinforcing members 732a disposed on the outer wall 31a is described. The n-th reinforcing member 732a(n) overlaps at least one end with another reinforcing member 732(n+1) and/or another reinforcing member 732(n−1). A length of an overlapping range is a length Lv. Between the plurality of reinforcing members 732a, the container member 31 or air is existed. Therefore, between the plurality of reinforcing members 732a is kept a high thermal resistance condition with respect to each other. As a result, heat transfer through one reinforcing member 732a(n) is suppressed.

FIG. 13 is a schematic graph for explaining heat transfer. (A) shows a model of heat transfer in the previous embodiment. (B) shows a model of heat transfer in this embodiment. The horizontal axis represents the length. The vertical axis represents a temperature TH of the high-temperature end 11 and a temperature TL of the low-temperature end 12.

In the preceding embodiment, the reinforcing member 32 is provided to extend between the high-temperature end 11 and the low-temperature end 12. This causes heat transfer through the reinforcing member 32. Heat transfer reduces the operation efficiency of the MHP device 1.

In this embodiment, the n-th reinforcing member 732a(n) provides only a part of the entire length of the element bed 2. Moreover, the n-th reinforcing member 732a(n) overlaps with the (n+1)-th reinforcing member 732a(n+1) or the (n−1)-th reinforcing member 732a(n−1) with respect to the longitudinal direction LD at least at one end. In this overlapping range, since the plurality of reinforcing members 732 are arranged on one wall, the wall can be reinforced. Moreover, the two overlapping reinforcing members 732 are separated each other. Therefore, heat transfer between the two reinforcing members 732 is suppressed.

In the drawing, the overlapping relationship with the n-th reinforcing member 732a(n) is illustrated. In addition, a temperature gradient of the n-th reinforcing member 732a(n) illustrated in (B) of FIG. 13 is smaller than a temperature gradient illustrated in (A) of FIG. 13 due to the high thermal conductivity of the reinforcing member 32. Therefore, the reinforcing member 32 suppresses the temperature inclination in one of the plurality of Cascade-connected element groups. For example, the length of one element group may correspond to the length of one reinforcing member 32.

According to this embodiment, heat transfer through the reinforcing member 32 can be suppressed even if the reinforcing member 32 is provided by a metal or the like having a high thermal conductivity. Moreover, since the plurality of reinforcing members 32 extend in the longitudinal direction LD while overlapping in the circumferential direction, partial strength insufficiency in the wall of the container 3 is suppressed.

### Eighth Embodiment

This embodiment is a modification in which the preceding embodiment is a base fundamental form. This embodiment provides one of manufacturing methods for the element bed 2 of the above embodiment.

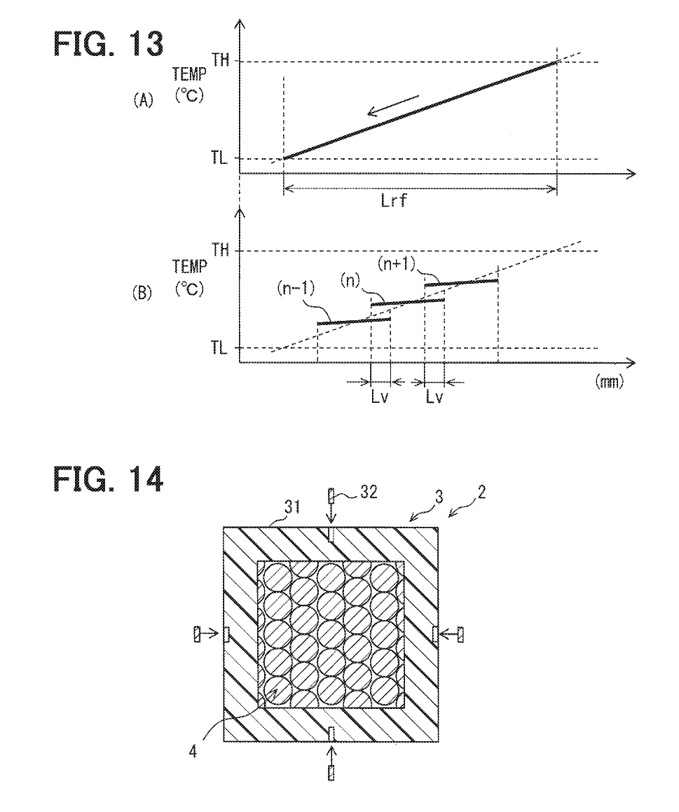

FIG. 14 shows one step of the method for manufacturing the element bed 2 of this embodiment. An order of steps described in this embodiment can be interchanged. A method for manufacturing the element bed 2 includes a step of preparing a container 3, a step of preparing an MCE element 4, and a step of placing the MCE element 4 in the container 3.

The step of preparing the container 3 includes a step of preparing a container member 31 which provides a main wall of the container 3. The step of preparing the container member 31 is also a stage of preparing a cylindrical member. When the container member 31 is provided by resin or aluminum, the cylindrical member is manufactured by a molding technique called injection molding, die casting or the like. The step of preparing the container member 31 may include a step of preparing a shape for providing the reinforcing member 32. This step includes a step of forming a groove for providing the reinforcing member 32 on the container member 31.

The step of preparing the container 3 includes a step of preparing the reinforcing member 32. The reinforcing member 32 is prepared as a rod-like member. The step of preparing the container 3 includes a step of attaching the reinforcing member 32 to the container member 31. The step of preparing the container 3 includes a step of mounting the reinforcing member 32 in the groove of the container member 31 along the radial direction. The reinforcing member 32 is fixed to the container member 31 by fixing means such as press fitting, adhesion, caulking or the like.

### Ninth Embodiment

This embodiment is a modification in which the preceding embodiment is a base fundamental form. This embodiment provides one of manufacturing methods for the element bed 2 of the above embodiment.

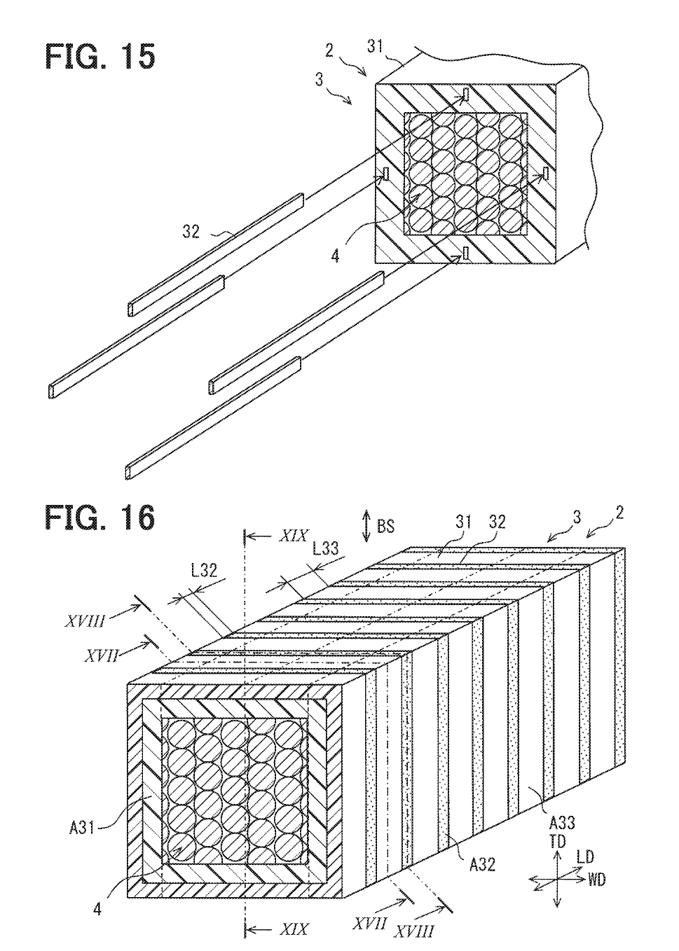

FIG. 15 shows one step of the method for manufacturing the element bed 2 of this embodiment. This embodiment provides a step of mounting the reinforcing member 32 to the container member 31. The step of preparing the container member 31 includes a step of forming a hole for providing the reinforcing member 32. The reinforcing member 32 is inserted into the hole along the longitudinal direction LD. In addition, the reinforcing member 32 may be insert molded in the container member 31.

### Tenth Embodiment

This embodiment is a modification in which the preceding embodiment is a base fundamental form. In the above embodiment, the reinforcing member 32 extends at least along the longitudinal direction LD. Alternatively, the reinforcing member may extend only in a circumferential direction of the container 3.

FIG. 16 shows an element bed 2 of this embodiment. The container 3 includes a cylindrical container member A31. The container member A31 extends over the entire length of the container 3. The container 3 has a plurality of reinforcing members A32. The reinforcing member A32 extends along the outer side of the container member A31. The reinforcing member A32 extends over the entire circumference of the container member A31. The reinforcing member A32 is annular to surround the entire circumference of the container member A31. Therefore, a plurality of reinforcing members A32 are arranged on the outer side of the container member A31. Predetermined intervals are provided between the plurality of reinforcing members A32. One reinforcing member A32 has a length L32 along the longitudinal direction LD.

The container 3 has a plurality of spacers A33. The plurality of spacers A33 are arranged between the plurality of reinforcing members A32. As a result, the plurality of reinforcing members A32 and the plurality of spacers A33 are alternately arranged on the outer side of the container member A31. One reinforcing member A32 has a length L33 along the longitudinal direction LD. The length L33 is smaller than the length L32. The spacer A33 can be provided by the same material as the container member A31. The thermal conductivity of the material of the spacer A33 is smaller than the thermal conductivity of the reinforcing member A32. Thereby, heat transfer between the high-temperature end 11 and the low-temperature end 12 is suppressed.

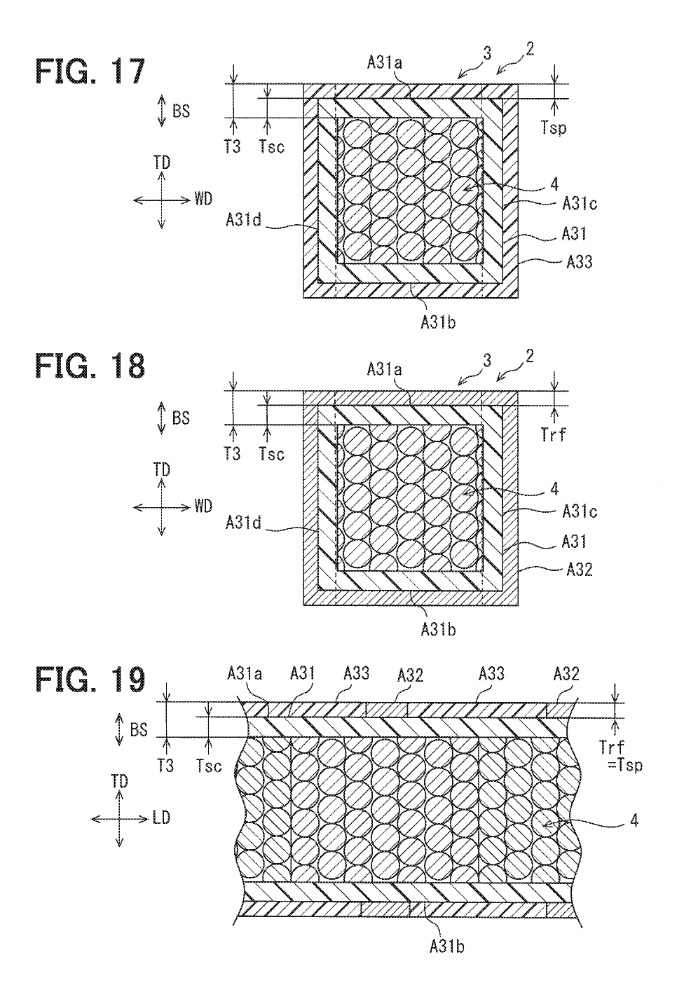

FIG. 17 shows a cross section taken along a line XVII-XVII in FIG. 16. The container member A31 has a thickness Tsc. The spacer A33 is an annular member having a thickness Tsp. The container member A31 and the spacer A33 provide the thickness T3 of the container 3. The thickness T3 provides the pressure resistance required for the container 3 by the material of the container member A31 and the material of the spacer A33. In this viewpoint, the spacer A33 is also a reinforcing member for the container member A31. A part of the spacer A33 reinforces an outer wall A31a and an inner wall A31b. In addition, a part of the spacer A33 reinforces a side wall A31c and a side wall A31d.

FIG. 18 shows a cross section taken along a line XVIII-XVIII in FIG. 16. The reinforcing member A32 is an annular member having a thickness Trf. The container member A31 and the reinforcing member A32 provide the thickness T3 of the container 3. The thickness T3 provides the pressure resistance required for the container 3 by the material of the container member A31 and the material of the spacer A33. A part of the reinforcing member A32 reinforces the outer wall A31a and the inner wall A31b. A part of the reinforcing member A32 reinforces the side wall A31c and the side wall A31d.

FIG. 19 shows a cross section taken along a line XIX-XIX of FIG. 16. Also in this embodiment, the reinforcing member A32 reinforces the outer wall A31a which is the overlapping wall and the inner wall A31b. The spacer A33 also reinforces the outer wall A31a which is the overlapping wall and the inner wall A31b. In this embodiment, the reinforcing member A32 is dispersed only in the longitudinal direction LD, so that the container member A31 is reinforced. The amount of deformation of the container member A31 in the longitudinal direction LD is suppressed.

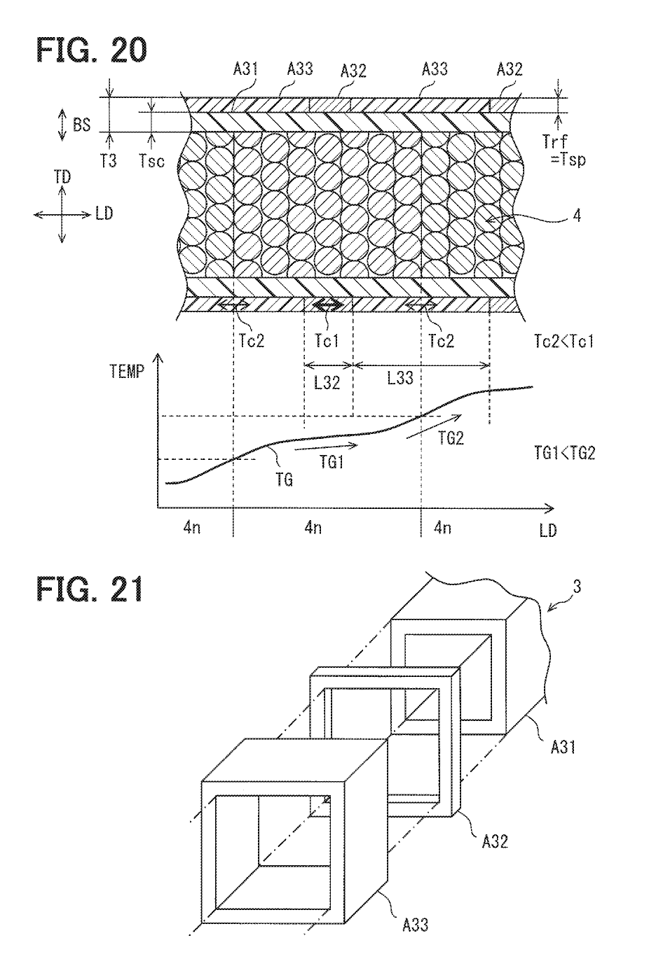

FIG. 20 shows a temperature distribution in FIG. 19. A thermal conductivity Tc1 provided by the reinforcing member A32 is larger than a thermal conductivity Tc2 provided by the spacer A33. Therefore, a heat transfer occurring in the reinforcing member A32 is larger than a heat movement occurring in the spacer A33. A curve of the temperature distribution TG shows the temperature gradient TG1 in a range including the reinforcing member A32. The curve of the temperature distribution TG shows the temperature gradient TG2 in a range including the spacer A33. The temperature gradient TG2 is larger than the temperature gradient TG1. In other words, in the reinforcing member A32, the temperature difference with respect to the longitudinal direction LD tends to be small. On the other hand, the spacer A33 acts so as to maintain the temperature difference. In this embodiment, since the length L32 is shorter than the length L33, a heat transfer due to the plurality of reinforcing members A32 is suppressed. On the other hand, since the length L33 is longer than the length L32, the temperature difference is maintained by the plurality of spacers A33.

The plurality of reinforcing members A32 and the plurality of spacers A33 can be arranged so as to coincide with the pitch of the plurality of element groups 4n. For example, it is possible to dispose the reinforcing member A32 at the central portion of one element group 4n and arrange the spacer A33 over the adjacent element group 4n. In such an arrangement, the temperature difference in one element group 4n is suppressed by the reinforcing member A32. Therefore, it is possible to dispose a plurality of particles 4a dispersedly arranged in the longitudinal direction LD within a single element group 4n in a narrow temperature zone. In addition, the spacer A33 disposed between the plurality of element groups 4n acts to maintain the temperature difference between the plurality of element groups 4n.

### Eleventh Embodiment

This embodiment is a modification in which the preceding embodiment is a base fundamental form. This embodiment provides one of manufacturing methods for the element bed 2 of the above embodiment.

FIG. 21 shows one step of the method for manufacturing the element bed 2 of this embodiment. A step of preparing the container 3 includes preparing an annular reinforcing member A32 and an annular spacer A33, and preparing a cylindrical container member A31. Further, a preparing step of the container 3 includes a step of alternately putting a plurality of reinforcing members A32 and a plurality of spacers A33 on the container member A31. This step is also a step of inserting the container member A31 along the longitudinal direction LD into the plurality of alternately arranged reinforcing members A32 and the plurality of spacers A33. In addition, the reinforcing members A32 may be insert-molded in a resin that provides the container member A31 and the spacers A33. In addition, the reinforcing members A32 and the spacers A33 may be formed into an annular shape by winding these materials around the outer periphery of the container member A31.

### Twelfth Embodiment

This embodiment is a modification in which the preceding embodiment is a base fundamental form. In the preceding embodiment, a reinforcing member 32, 732, A 32 having a quadrilateral or quadrangular cross section is used. Alternatively, a reinforcing member having various cross-sectional shapes can be used. This embodiment employs a reinforcing member having a cross section whose major axis is inclined with respect to the direction of the magnetic flux BS.

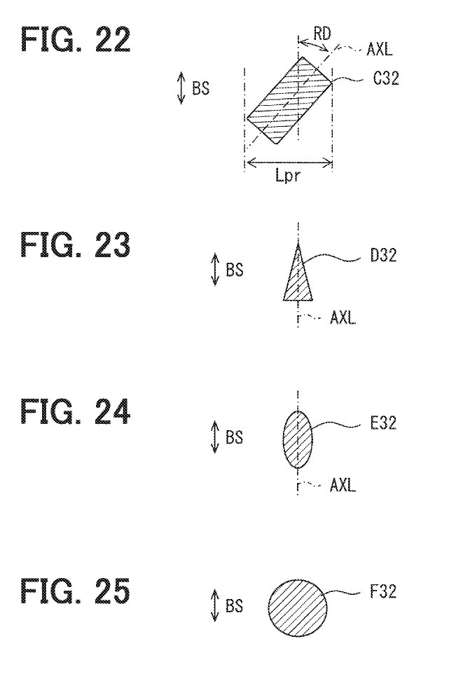

FIG. 22 shows a cross section orthogonal to the longitudinal direction LD of the reinforcing member C32. The reinforcing member C32 has a cross section which can be referred to as a quadrilateral shape or a quadrangular shape. It can be said that the cross section of the reinforcing member C32 has a vertically long cross section. However, the major axis AXL defining the vertically long cross section is inclined by the inclination angle RD with respect to the direction of the magnetic flux BS, The inclination angle RD is set so as to suppress a projected length Lpr (projected area) in the direction of the magnetic flux BS. For example, since the maximum value of the projected length Lpr is determined according to an aspect ratio of the cross section of the reinforcing member C32, the inclination angle RD is set so as to make the projected length Lpr smaller than the maximum value.

Since the shorter the projected length Lpr, the smaller the projected area of the reinforcing member C32, the magnetic adverse effect due to the reinforcing member C32 is suppressed. For example, when the reinforcing member C32 is provided by a conductive material, a loss due to the eddy current is suppressed. In addition, in a case where the reinforcing member C32 is provided by a material which generates heat by the interlinkage with the magnetic flux BS, a decrease in a temperature difference between the high-temperature end 11 and the low-temperature end 11 due to heat discharge is suppressed. Further, in a case where the reinforcing member C32 is provided by a magnetic material, concentration of the magnetic flux on the reinforcing member C 32 can be suppressed.

### Thirteenth Embodiment

This embodiment is a modification in which the preceding embodiment is a base fundamental form. This embodiment employs a reinforcing member D32 having a cross section which can be referred to as a triangle or a trilateral having a major axis AXL parallel to the direction of the magnetic flux BS.

FIG. 23 shows a cross section orthogonal to the longitudinal direction LD of the reinforcing member D32. The reinforcing member D32 has a cross section like an isosceles triangle. The major axis AXL defining the elongated cross section is parallel to the direction of the magnetic flux BS. Also in this embodiment, the longitudinal axis AXL of the reinforcing member D32 may be inclined with respect to the direction of the magnetic flux BS.

### Fourteenth Embodiment

This embodiment is a modification in which the preceding embodiment is a base fundamental form. This embodiment employs a reinforcing member E32 having a cross section which can be referred to as an ellipse having a major axis AXL parallel to the direction of the magnetic flux BS.

FIG. 24 shows a cross section orthogonal to the longitudinal direction LD of the reinforcing member E32. The reinforcing member E32 has a cross section like an ellipse. The major axis AXL defining the elongated cross section is parallel to the direction of the magnetic flux BS. Also in this embodiment, the longitudinal axis AXL of the reinforcing member E32 may be inclined with respect to the direction of the magnetic flux BS. Further, the cross section of the reinforcing member E32 can be provided by various cross-sectional shapes such as an oval shape, a semicircular shape, an arc shape surrounded by an arc and a string, and the like.

### Fifteenth Embodiment

This embodiment is a modification in which the preceding embodiment is a base fundamental form. This embodiment employs a reinforcing member F32 having a cross section which is called a circular shape.

FIG. 25 shows a cross section orthogonal to the longitudinal direction LD of the reinforcing member F32. The reinforcing member F32 has a circular cross section. Also in this embodiment, the overlapping wall can be reinforced by the reinforcing member F32. As a result, restrictions in terms of mechanical strength are reduced, and instead, materials and/or shapes of overlapping walls can be set from a magnetic viewpoint. In addition, since the overlapping wall mainly passing the magnetic flux making the interlinkage with the MCE element 4 is reinforced, loss caused by the container 3 is suppressed.

### Other Embodiments

The disclosure in this specification is not limited to the illustrated embodiment. The disclosure encompasses the illustrated embodiments and modifications by those skilled in the art based thereon. For example, the disclosure is not limited to the parts and/or combinations of elements shown in the embodiments. The disclosure can be implemented in various combinations. The disclosure may have additional parts that may be added to the embodiment. The disclosure encompasses omissions of parts and/or elements of the embodiments. The disclosure encompasses replacement or combination of parts and/or elements between one embodiment and another. The disclosed technical scope is not limited to the description of the embodiment. Several technical scopes disclosed are indicated by descriptions in the claims and should be understood to include all modifications within the meaning and scope equivalent to the descriptions in the claims.

In the above embodiment, the rod-like reinforcing member 32 is utilized. Alternatively, it is possible to use reinforcing members having various shapes such as a net shape and a wave shape.

Also, the shape of one embodiment can be applied to other embodiments. For example, a configuration in which the overlapping wall is thinner than the side wall can be adopted in all the embodiments.

What is claimed is:

1. An element bed for a magnetocaloric cycle device, comprising:
a magnetocaloric effect element performing a magnetocaloric effect; and
a container containing the magnetocaloric effect element, the container has a container member for providing walls of the container, and a reinforcing member disposed partially on the container member for reinforcing the container member.

2. The element bed for a magnetocaloric cycle device claimed in claim 1, wherein the container member is made of a nonmagnetic material.

3. The element bed for a magnetocaloric cycle device claimed in claim 1, wherein the reinforcing member is made of a magnetic material.

4. The element bed for a magnetocaloric cycle device claimed in claim 3, wherein the reinforcing member has a vertically elongated cross section along a direction of a magnetic flux supplied to the magnetocaloric effect element.

5. The element bed for a magnetocaloric cycle device claimed in claim 1, wherein the container member has an overlapping wall overlapping with the magnetocaloric effect element with respect to the direction of the magnetic flux supplied to the magnetocaloric effect element, and the reinforcing member is disposed at least on the overlapping wall.

6. The element bed for a magnetocaloric cycle device claimed in claim 1, wherein the container member is a cylindrical member, and the overlapping wall is thinner than the other walls.

7. The element bed for a magnetocaloric cycle device claimed in claim 1, wherein the reinforcing member has a plurality of reinforcing members that are separated from each other in the longitudinal direction.

8. The element bed for a magnetocaloric cycle device claimed in claim 1, wherein the reinforcing member has an annular reinforcing member circumferentially surrounding the container member.

9. A magnetocaloric cycle device comprising:
the element bed for a magnetocaloric cycle device claimed in claim a magnetic field modulation device for modulating a magnetic field applied to the magnetocaloric effect device; and
a heat transport device for generating a reciprocating flow of a heat transport medium that performs a heat exchange with the magnetocaloric effect device.

10. A magnetocaloric cycle device comprising:
an element bed for a magnetocaloric cycle device claimed in claim 5;
a magnetic field modulation device for modulating a magnetic field applied to the magnetocaloric effect device; and
a heat transport device for generating a reciprocating flow of a heat transport medium that performs a heat exchange with the magnetocaloric effect device, further comprising:
a bed group in which the plurality of element beds are arranged along a circumferential direction, wherein the direction of the magnetic flux is a radial direction, the overlapping wall is an outer wall and an inner wall facing in a radial direction, and the plurality of element beds are arranged to face side walls other than the overlapping wall.
